(19) United States
(12) Patent Application Publication
(10) Pub. No.: US 2016/0117633 A1
(43) Pub. Date: Apr. 28, 2016

(54) INFORMATION PROVIDING SYSTEM AND SALES SETTLEMENT TERMINAL

(71) Applicant: TOSHIBA TEC KABUSHIKI KAISHA, Tokyo (JP)

(72) Inventor: Kazunori Kato, Izu (JP)

(21) Appl. No.: 14/522,673

(22) Filed: Oct. 24, 2014

(51) Int. Cl. G06Q 10/08

(52) U.S. Cl. CPC G06Q 10/087

(57) ABSTRACT

An information providing system for selling commodities comprises a tag for storing information; a server comprising a customer information management section to manage various information of a customer; a commodity information storage section to store various information of a commodity for sale; a commodity information temporary storage section to store information of the currently purchased commodities; and a providing information creation section to create information for a specific customer; a sales settlement terminal comprising a data temporary storage section to store the data of the purchased commodities; a purchase amount calculation section to calculate the settlement amount of the purchased commodities; and an information recording antenna section to record the information provided to the specific customer in the tag; and an information acquisition antenna section to be connected with the server to acquire the information stored in the tag.

### FIELD

Embodiments described herein relate to an information providing system and a sales settlement terminal in a commodity settlement terminal.

### BACKGROUND

In a selling store such as a supermarket and the like, various kinds of information are provided to customers. It is known that in the provided information, if there is the information provided to an unspecific number of customers such as special-sale product information and the like, then information limited to a commodity purchaser is provided by mastering the purchaser attribute. Further, it is known that cooking recipe information is provided aiming at the foodstuffs placed in the shopping cart in which commodities purchased by the commodity purchaser are put. Information limited to a commodity purchaser may be provided by recognizing the foodstuffs in the shopping cart. However, to recognize the foodstuffs in a shopping cart, it is needed to attach a non-contact tag which is called a RFID chip to a commodity and these RFID chips needs to be attached to all the commodities, which leads to a rise in the unit price of the commodity.

### BRIEF DESCRIPTION OF THE DRAWINGS

FIG. 1 is a diagram illustrating the constitution example of a system according to embodiment 1;

FIG. 2 is a diagram illustrating the constitution example of a POS terminal of the system according to embodiment 1;

FIG. 3 is a diagram illustrating the constitution example of a server of the system according to embodiment 1;

FIG. 4 is a flowchart illustrating a sales processing carried out in the POS terminal according to embodiment 1;

FIG. 5 is an example of items of the customer data according to embodiment 1;

FIG. 6 is a diagram illustrating the constitution example of the surroundings nearby a sacker table for customer according to embodiment 1; and

FIG. 7 is a flowchart illustrating the processing carried out nearby the sacker table according to embodiment 1.

### DETAILED DESCRIPTION

An information providing system used in a store for selling commodities comprises a tag for storing information; a server comprising a customer information management section configured to manage various information of a customer, including the information of the commodities purchased by the customer in the past; a commodity information storage section configured to store various information of a commodity for sale; a commodity information temporary storage section configured to store information of the currently purchased commodities; and a providing information creation section configured to create information for a specific customer according to an extraction condition preset according to the information of the specific customer stored in the customer information management section and the information of the currently purchased commodities after the currently purchased commodities are settled; a sales settlement terminal comprising a data temporary storage section configured to store the data of the purchased commodities; a purchase amount calculation section configured to calculate the settlement amount of the purchased commodities; and an information recording antenna section configured to record the information provided to the specific customer in the tag; and an information acquisition antenna section configured to be connected with the server to acquire the information stored in the tag.

### Embodiment 1

The information providing system and the sales settlement terminal according to embodiment 1 are described below in detail with reference to the accompanying drawings.

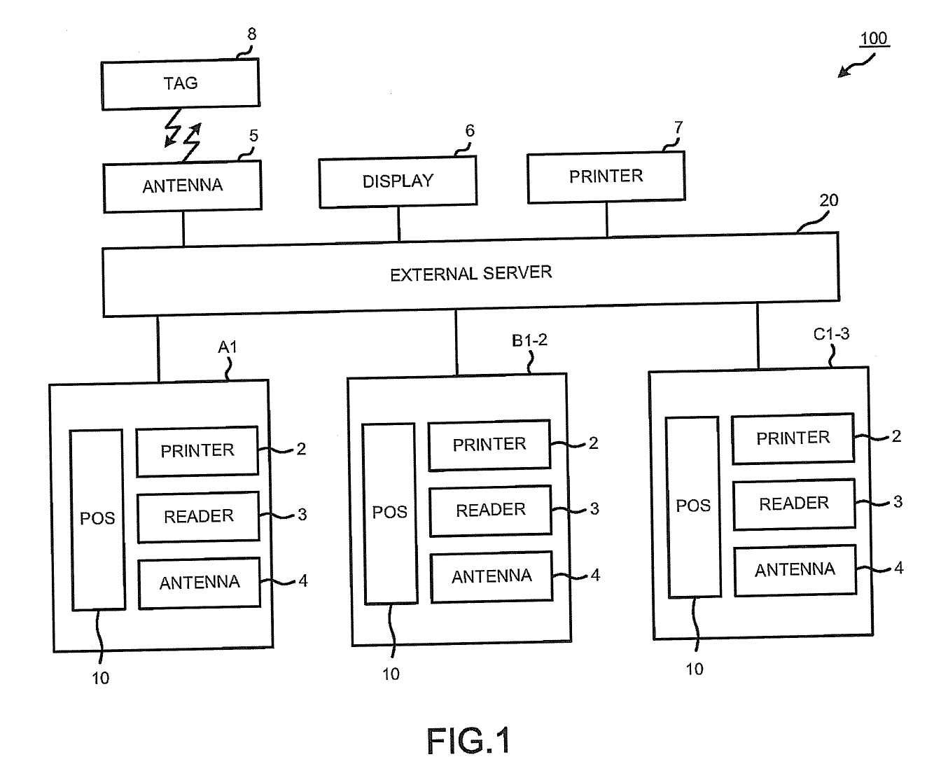

FIG. 1 is a diagram illustrating the constitution example of the system according to embodiment 1.

The information providing system 100 consists of an external server 20 for managing customer information or various information of a purchased commodity and the like, a store A1, a store B1-2, a store C1-3, an antenna 5, a display 6, a printer 7 and the under-mentioned tag 8 which are connected with the external server 20 via a network. Further, more than one antenna 5, display 6 and printer 7 may be connected with the external server 20, and more than one tag 8 may be used by the information providing system 100.

The store A1 is a commodity selling store which is connected with a printer 2 for outputting a receipt after a selling commodity is settled, a reader 3 for reading a commodity code such as a barcode and the like attached to a commodity or membership information from a member card held by a customer who is to purchase the commodity and an antenna 4 for writing information into the tag 8 along with a POS (Point Of Sales) terminal 10 serving as a sales settlement terminal for settling the commodities for sale.

Further, like the store A1, the store B1-2 and the store C1-3 both comprise a POS terminal 10, a printer 2, a reader 3 and an antenna 4.

Although three stores are described in the system, the number of the stores in the system may be 1, 2, 4 or more. Further, a plurality of POS terminals 10, printers 2, readers 3 and antennas 4 may be arranged in one store.

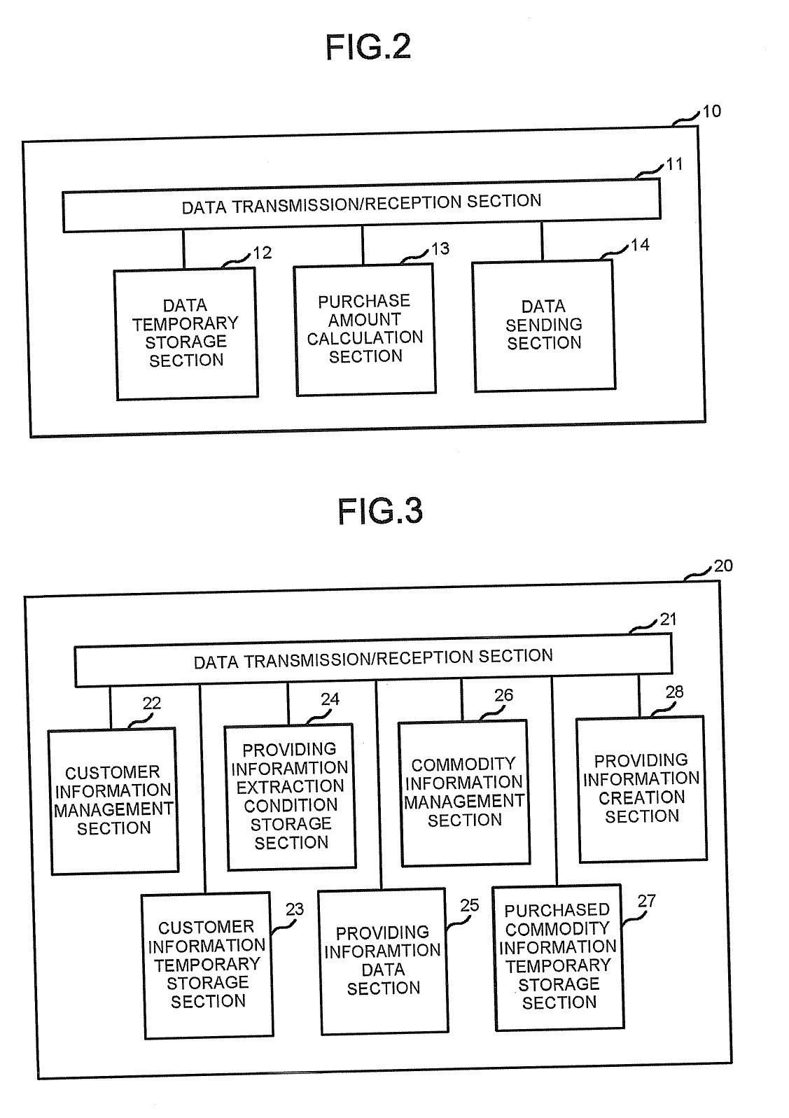

The POS terminal 10 serving as a sales settlement terminal is described in detail with reference to FIG. 2. The POS terminal is provided with a data temporary storage section 12 configured to temporarily store the desired purchase commodities a customer who is to purchase the commodities brings to a checkout counter and a customer number; a purchase amount calculation section 13 configured to calculate the settlement amount of the purchased commodities; and a data sending section 14 configured to send data to the tag attached to the basket of a customer via the antenna 4. Further, a data transmission/reception section 11 for carrying out data transmission/reception with the outside is also arranged.

Next, the external server 20 is described in detail with reference to FIG. 3. The external server 20 comprises a customer information management section 22 configured to manage customer information; a customer information temporary storage section 23 configured to temporarily store information of the current customer; a providing information extraction condition storage section 24 configured to store an extraction condition for the extraction of the information provided to a customer; a providing information data section 25 configured to store the information before the information is extracted to provide to a customer; a commodity information management section 26 configured to store the commodity information such as the commodity name, price and the like of the commodity to be sold; a purchased commodity information temporary storage section 27 configured to temporarily store the information of the commodities currently purchased by a customer; and a providing information creation section 28 configured to create the information provided to a customer from the providing information data section 25 according to the extraction condition stored in the providing information extraction condition storage section 24. Further, a data transmission/reception section 21 for carrying out data transmission/reception with the outside is also arranged.

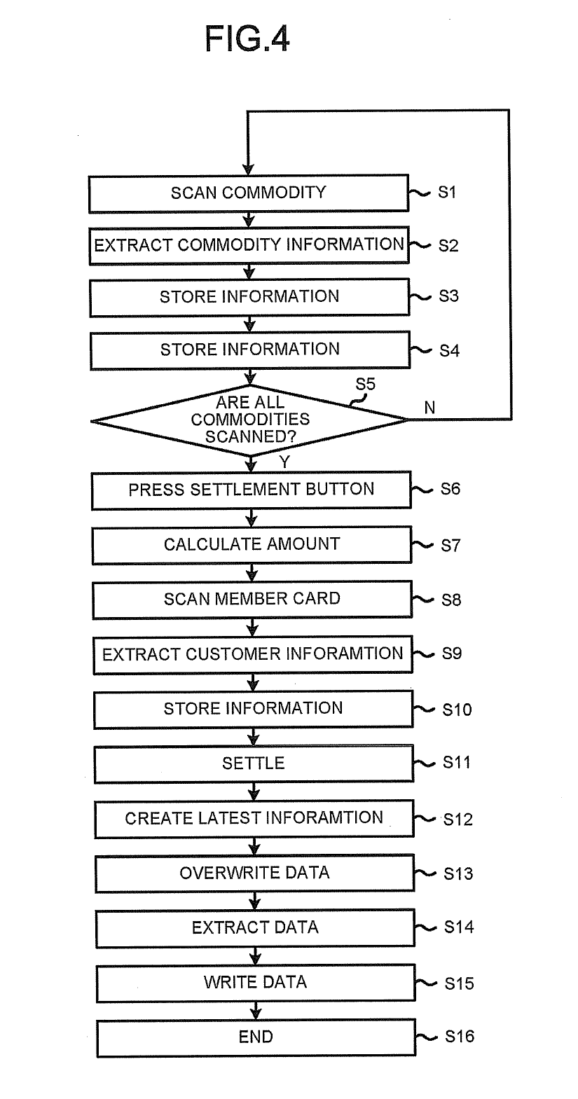

The flow of the notification of an information providing system for provide different information for different customers is described below with reference to FIG. 4-FIG. 7. Further, in the embodiment, it is assumed that a customer completes a member registration in advance every time the customer shops in a store, and the information of the customer is stored in the customer information management section 22 which will be described later.

A customer, who is to purchase the commodities, brings desired purchase commodities to a settlement place. The operator in the store A1 scans the barcode and the like attached to a purchased commodity with a reader 3, such as a scanner and the like, connected with the POS terminal 10 to acquire a commodity code and sends the acquired commodity code to the external server 20 (S1). The scanned desired purchase commodity is transferred to a basket 9 on which a tag 8 is set in advance.

The commodity information management section 26, in which information, such as a commodity name, an amount, a commodity maker and the like, is stored in association with a commodity code, is arranged in the external server 20.

The external server 20 extracts the corresponding commodity information from the received commodity code (S2) and stores the extracted commodity information in the purchased commodity information temporary storage section 27 (S3) and synchronously returns the commodity information to the POS terminal 10. The POS terminal 10 stores the information in the data temporary storage section 12 (S4).

The operator scans each desired purchase commodity a customer, who is to purchase the commodity, brings to the settlement place. The operator confirms whether or not all the commodities are scanned (S5), continues to scan the rest commodities (S1) if not all the commodities are scanned (NO in S5). That is, through the scanning, the commodity information of all the commodities is stored in the purchased commodity information temporary storage section 27 and the data temporary storage section 12.

The operator presses a settlement button (not shown) arranged on the POS terminal 10 (S6) if all the commodities are scanned (YES in S5). When the settlement button is pressed (S6), the purchase amount calculation section 13 calculates the current settlement amount using the commodity information stored in the data temporary storage section 12 (S7).

Further, the customer, who is to purchase the commodities, hands the operator a member card and the desired purchase commodities. The operator in the store A1 scans the member card with the reader 3 such as a scanner and the like connected with the POS terminal 10 (S8) and sends the acquired customer number to the external server 20.

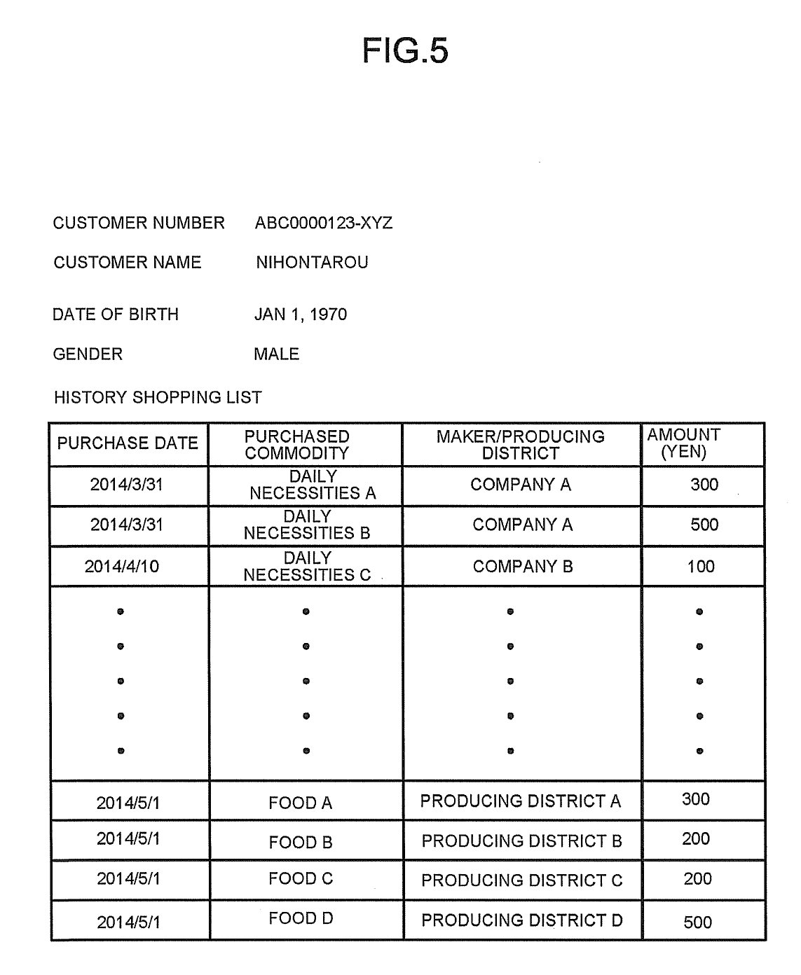

The customer information management section 22, in which a customer name, the date of birth, gender and a history shopping list are stored in association with a customer number, as shown in an example in FIG. 5, is arranged on the external server 20. The external server 20 extracts the corresponding customer information from the received customer number (S9) and stores the extracted customer information in the customer information temporary storage section 23 (S10).

Herein, the operator performs the settlement by reference to the amount calculated by the purchase amount calculation section 13 and by carrying out the charge giving and receiving with the customer who is to purchase the customer to complete the settlement (S11). A receipt is issued from the printer 2 after the settlement is completed.

The external server 20, after receiving information indicating the settlement is completed from the POS terminal 10, adds the information, which is recorded in the purchased commodity information temporary storage section 27, of the customer who currently purchased commodities to the information stored in the customer information temporary storage section to create the latest customer information (S12) and overwrites the information in the customer information management section 22 with the latest customer information (S13). Further, latest information of the purchased commodities settled through the current settlement processing is also recorded in the purchased commodity information temporary storage section 27 at this moment.

Next, the providing information creation section 28 of the external server 20 extracts, from the providing information data section 25, information corresponding to a retrieval condition pre-stored in the providing information extraction condition storage section 24 using the commodity information stored in the purchased commodity information temporary storage section 27 (S14). Further, the retrieval condition pre-stored in the providing information extraction condition storage section 24 can be optionally set by a selling store. For example, a discount information of a company A is provided to a customer if the customer purchases more than ★ products manufactured by the company A in the past three months, or a recipe ★★ is provided if the commodities purchased today include ∘∘, □□, ΔΔ and ⋆⋆, and the like. Further, more than one retrieval condition may be set.

Sequentially, the providing information creation section 28 sends the created providing information data to the data sending section 14 of the POS terminal 10. The data sending section 14 writes the providing information data into the tag 8 arranged on the basket 9 (S15) to complete the sales processing (S16)

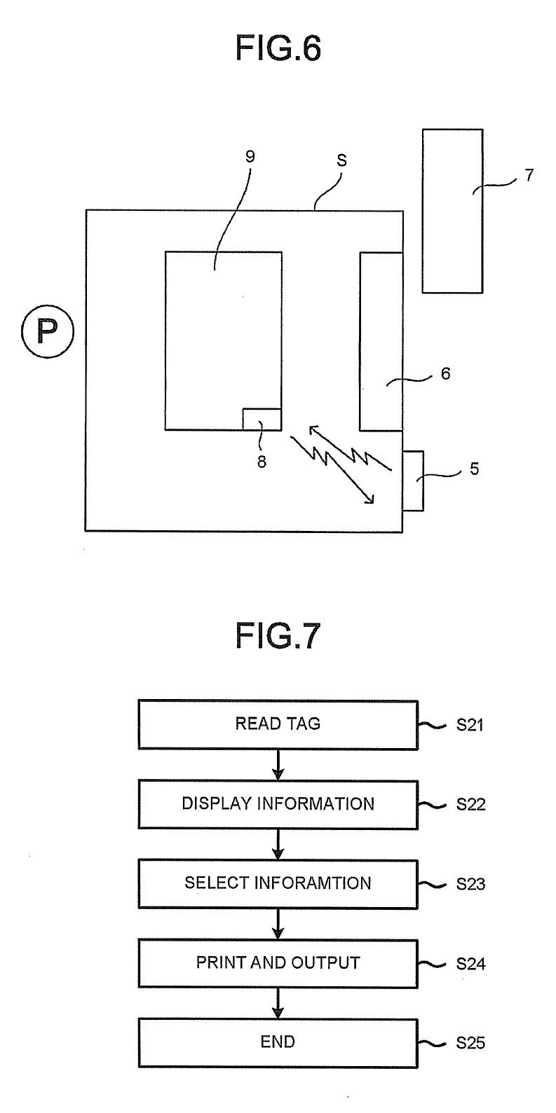

The customer who is to purchase the commodity and for whom the settlement is completed moves the basket 9 in which the settled commodities are put from the POS terminal 10 to a sacker table S. Then, the settled commodities are bagged into a bag (not shown) from the basket 9, as shown in FIG. 6. FIG. 6 is a top view illustrating the surroundings of the sacker table S, in which P represents a customer.

The antenna 5 which serves as a long-time reader is arranged nearby the sacker table S to transmit electric wave. When the customer brings the basket 9 into the area of the electric wave, the tag 8 on the basket 9 detects the electric wave and the information of the tag 8 is read (S21). Information extracted for the customer is stored in the tag 8, as stated above, and the external server 20 displays the information on the display 6 (S22). When the customer selects desirable information on the screen from the information displayed on the display 6 (S23), the selected information is printed and output by the printer 7 nearby the sacker table S (S24), and then the sales and the information provision are ended (S25). Further, in a case where the sacker table S is used by a plurality of customers, the display 6 may be arranged on the basket 9 but not nearby the sacker table S. Further, if the printer 7 is not arranged nearby the sacker table S, an information providing number is notified to the customer when the customer selects desirable information on the display 6, then the customer goes to the place where the printer 7 is arranged and inputs the number into the printer 7 to print and output the desirable information.

As stated above, information which is considered as proper for a customer is provided to the customer according to the commodities purchased by the customer currently or in the past after the settlement is ended. Thus, compared with the information provided to an unspecific number of customers, the information in which a customer considered to have deep interest can be provided. Moreover, it is considered that a commodity settlement is delayed as the commodity settlement is carried out after the information before the commodity settlement, and especially the information nearby the POS terminal 10 is acquired. However, in the present invention, as information is provided after the end of a settlement, no delay in settlement processing is caused in the POS terminal 10. Further, as commodity information is acquired by scanning commodities during a settlement process, information of the currently purchased commodities can be obtained before a settlement, needing no preset RFID tags. Thus, the time spent on mounting a RFID tag is saved. Further, in the conventional technology, as an RFID tag preset on a commodity is scrapped after being used, it is sometimes considered to add the cost of a RFID tag to the unit price of a commodity. However, it is not needed to arrange a RFID tag on a commodity in the present embodiment, thus preventing the increase in the unit price of a commodity.

### Embodiment 2

An information providing system according to embodiment 2 is described below. In embodiment 2, information other than the selling store the customer shops currently is stored in the providing information data section 25, meanwhile, an extraction condition for the extraction of the providing information other than the selling store the customer shops currently is stored in the providing information extraction condition storage section 24.

As shown in FIG. 5, information such as age and gender is also stored as customer information. Thus, information relating to a nearby cooperative store is provided to a customer based on the information. For example, information relating to a nearby sports shop OO is provided for a 40-year-old male customer.

Thus, compared with the information provided to an unspecific number of customers, the information in which a customer considered to have deep interest can be provided, and the possibility that the user is more likely to shop in another nearby cooperative stores and the like is increased.

### Embodiment 3

An information providing system according to embodiment 3 is described below in detail. In embodiment 3, the position information of the selling store a customer shops currently is stored in the providing information data section 25, meanwhile, an extraction condition for the extraction of providing information taking the position information of the selling store a customer shops currently into consideration is stored in the providing information extraction condition storage section 24.

Sometimes, the commodities produced by the same company are sold in a plurality of stores. If all the stores are adjacent, the information relating to other nearby cooperative stores provided in any one of the plurality of stores may be useful to a customer. However, the stores in which the commodities produced by the same company are sold may be far away from each other in some cases. If customer information can be collectively managed by the same company sharing the external serve 20, it is considered that other cooperative stores are far away from the current store when the extraction condition stored in the providing information extraction condition storage section 24 is the same for all the stores. In this case, the information of the cooperative stores may be useless to the customer.

Thus, in embodiment 3, the position information of the selling store a customer shops currently is stored in the providing information data section 25, and an extraction condition for the extraction of providing information taking the position information of the selling store a customer shops currently into consideration is stored in the providing information extraction condition storage section 24. For example, it is limited to extract information from a cooperative store not more than 1 km away from the current store.

As a consequence, the extracted data to be provided is merely the information of a nearby store, thus, compared with the information provided to an unspecific number of customers, the information in which a customer considered to have deep interest can be provided, and the possibility that the user is more likely to shop in another nearby cooperative stores and the like is increased.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An information providing system used in a store selling commodities, comprising:
a tag for storing information;
a server comprising: a customer information management section configured to manage various information of a customer, including the information of the commodities purchased by the customer in the past; a commodity information storage section configured to store various information of a commodity for sale; a commodity information temporary storage section configured to store information of the currently purchased commodities; and a providing information creation section configured to create information for a specific customer according to an extraction condition preset according to the information of the specific customer stored in the customer information management section and the information of the currently purchased commodities after the currently purchased commodities are settled;
a sales settlement terminal comprising: a data temporary storage section configured to store the data of the purchased commodities; a purchase amount calculation section configured to calculate the settlement amount of the purchased commodities; and an information recording antenna section configured to record the information provided to the specific customer in the tag; and
an information acquisition antenna section configured to be connected with the server to acquire the information stored in the tag, wherein the information acquisition antenna section is arranged at a sacker table and is further configured to receive the information provided to the specific customer by the tag, and wherein the sacker table comprises a display section configured to display the information received by the information acquisition antenna section.

2. The information providing system according to claim 1, further comprising:
at least one of a printer section configured to print the information provided to the specific customer and a display section configured to display the information provided to the specific customer.

3. The information providing system according to claim 2, wherein
the preset extraction condition further includes a condition for extracting other information rather than information related to the store for selling the commodity.

4. The information providing system according to claim 2, wherein
the preset extraction condition further includes the position information of the store for selling the commodity.

5. A sales settlement terminal, comprising:
a code information acquisition section configured to extract a fixed code attached to a commodity;
a commodity information temporary storage section configured to temporarily store the fixed commodity information corresponding to the code extracted from a commodity information storage section in which commodity information is stored;
a code information acquisition section configured to extract the fixed code of a customer; and
an information record antenna section configured to write, into a tag for storing information, the information which is extracted according to a preset extraction condition after a commodity settlement and is to be provided to a specific customer, wherein the information record antenna section is arranged at a sacker table and is further configured to receive the information provided to the specific customer by the tag, and wherein the sacker table comprises a display section configured to display the information received by the information record antenna section.
